(19) United States
(12) Patent Application Publication
(10) Pub. No.: US 2026/0357444 A1
(43) Pub. Date: Nov. 12, 2026

(54) SYSTEM AND METHOD FOR SEPARATING TWO GASES FROM A SAME SOLUTION AND CAPTURING AT LEAST ONE GAS

(71) Applicant: E9 HYDROGEN, INC., SANDY, OR (US)

(72) Inventors: Darrel Vance SMITH, Estacada, OR (US); Blake Fuqua PUTNEY, JR., Palo Alto, CA (US); Mark ALLEN, Littleton, CO (US); Benjamin ROBERTS, Los Altos, CA (US)

(73) Assignee: E9 Hydrogen, Inc., SANDY, CA (US)

(21) Appl. No.: 19/204,438

(22) Filed: May 9, 2025

(51) Int. Cl. C25B 1/044; C25B 9/015; C25B 11/03; C25B 15/08

(52) U.S. Cl. CPC C25B 1/044; C25B 9/015; C25B 11/03; C25B 15/083

(57) ABSTRACT

A system and method to separate two gases in a same solution and filtering and channeling at least one of the gases away from the solution. In one version, variances in sizes and therefore buoyancy of the bubbles of the two gases are exploited to separate the two gases and filter and channel at least one of the two gases; in other applications variances in density of the two gases are exploited to separate the two gases and filter and channel at least one of the two gases. Variances in electrical charge of the two gases are exploited to separate the two gases and filter out and channel one of the two gases. The solution may be electrolytic in certain cases and the two gases of interest are hydrogen and oxygen that are freed by an electrolytic process from a solution having water as a solvent.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

UK Patent Application GB 2604855, filed Aug. 3, 2021 and titled “Electrolyte Additive”;

US Patent Application US 2015/0116832 A1, filed Oct. 24, 2013, Abandoned, Published Apr. 30, 2015 and titled “Electrochemical Device for Producing Hydrogen”; PCT Patent Application WO2016063206A1 titled “Membrane-less electrolyzer” published on Apr. 28, 2016; and U.S. Pat. No. 5,783,051A titled “Apparatus for producing hydrogen and oxygen” are incorporated herein by reference in their entirety and for all purposes” issued on Jul. 21, 1998.

### FIELD OF THE INVENTION

The present invention is related generally to separating gases in a same solution, and more particularly to systems and methods for separating by filtering of distinguishable gases in a same solution on the basis of differing characteristics of the two gases.

### BACKGROUND OF THE INVENTION

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

Many solutions contain constituents that can be processed to be released in gaseous form, to include, but not limited to, (a.) water, (b.) alcohol, (c.) petroleum, (d) antifreeze, (e.) whiskey, (f.) vinegar, and (g.) biodiesel.

In one area of the prior art, extracting hydrogen gas an electrolytic process from a solution having water as a solvent; the prior art has largely been motivated by the recognition that hydrogen energy has features such as an inexhaustible supply, pollution-free, and high thermal efficiency, and many researchers have investigated various leading candidates for future new energy.

The methods of producing hydrogen are classified into two kinds. One method is to decompose water to produce hydrogen and oxygen using electrolysis. Prior art methods for releasing hydrogen gas using water electrolysis may become indispensable in evolving society toward of a clean energy system. Prior art techniques for producing hydrogen are performed by water electrolysis using a low-temperature solid electrolyte film.

It is an object of the present invention to provide a system and method to free and separate one or more gases from a solution, and thereupon channel and capture at least one of these free gases. It is an additional object of the invention to provide an apparatus and a method for producing hydrogen and a method for producing hydrogen which effectively produce hydrogen in the low humidity atmosphere with no humidifier nor dehumidifier, and an electrochemistry device and a method which generates electrochemistry energy by an oxidation-reduction reaction using hydrogen without the use of a membrane separating the anode and cathode. The prior art focuses on electrolytic production of hydrogen and incorporates membranes of several types to limit migration of ions between the anode and cathode. The advantages of the invented membrane-less method are multiple, including, but not limited to, lower energy consumption, operation at room temperature, ability to stop and start the electrolytic process without delays or inefficiencies, and the use of low alloy steel as well as other materials for the anode and cathode.

### BRIEF SUMMARY OF THE INVENTION

One consequence of the removal of a prior art membrane intervening between the anode and cathode is that hydrogen gas and oxygen gas can coexist in the same water volume, creating the need to separate the two gases in other ways. Therefore, one object of the method of the present invention (hereinafter, “the invented method”) that are made obvious to one of ordinary skill in the art in light of the present disclosure, provides a first preferred embodiment of the present invention that relies upon variances in sizes of gas molecules to separate at least one gas from the other in the comprising solution, and to channel and capture at said at least one gas.

In an alternate preferred embodiment of the present invention this separation relies upon variances in density of two or more gases to free and separate said gases within a solution, and separately channeling at least one of the two gases.

Another preferred embodiment of the present invention includes one or more of the following aspects: (a.) means to generate via electrolysis a first gas and a second gas from the solution; (b.) means to separate the first gas from the second gas, whereby the first gas is entrained within the solution; and (c.) means to extract the separated and entrained first gas while inhibiting the second gas from being extracted with the entrained first gas.

In a still alternate preferred embodiment of the present invention, variances in electrical charge of at least two gases are exploited to separate the two gases and channel at least one of the two gases.

In a yet alternate preferred embodiment of the present invention, in electrolytic solution having water as its solvent, hydrogen gas and oxygen gas are separately freed from water molecules such that the hydrogen gas is filtered out of the solution and captured.

In even alternate preferred embodiments of the present inventions include one or more of the aspects of (a.) a tank forming an inner volume, the inner volume containing an electrolytic solution (“the solution”) and the tank configured to enable gaseous emissions to escape upwards from the solution, wherein the solution comprises water as a solvent, (b.) an input feature coupled with and through which the solution flows into the inner volume, which consists of at least one tubular anode; (c.) at least one perforated cathode (“the cathode”) positioned at least partially within the tubular anode, the cathode forming a cylindrical cathode volume, wherein a plurality of cathode perforations of the cathode are sized to both permit gaseous hydrogen to enter the cylindrical cathode volume and obstruct gaseous oxygen from passing into the cylindrical cathode volume, whereby the cathode and the at least one tubular anode in combination are configured to electrolyze the solvent and thereby generate gaseous hydrogen and gaseous oxygen, and wherein the gaseous hydrogen is free to become entrained in the solution and the gaseous oxygen is free to escape upwards and away from the tubular cathode, and the solution with entrained gaseous hydrogen are both permitted to enter the cylindrical cathode volume; (d.) an output channel through which the solution exits the tank; (e.) a pump coupled with the output channel and configured to generate a pulling force within the output channel, whereby the solution and the gaseous hydrogen entrained in the solution are pulled out of the tank; (f.) a skimmer basin positioned at a top of the tank and above the input feature, and the skimmer basin shaped and positioned to accept an overflow of solution from the top of the tank, coupled with a skimmer channel that is shaped and configured to enable the solution with entrained hydrogen to exit the skimmer basin; and (g.) a perforated skimmer screen forming a plurality of skimmer perforations, the perforated screen positioned between the top of the tank and the skimmer channel, wherein the skimmer perforations are each sized to both permit the solution with entrained gaseous hydrogen to flow out of the tank and to obstruct gaseous oxygen from entering the skimmer channel; (h.) a skimmer pump coupled with the skimmer channel and configured to generate a pulling force within the skimmer channel, whereby the solution and the gaseous hydrogen entrained in the solution are pulled out of the tank via the skimmer.

Yet additional alternate preferred embodiments of the present inventions comprise one or more of the following aspects a.) a plurality of anodes; (b.) a plurality of perforated cathodes (“the cathodes”), each cathode forming an individual cathode volume, whereby the cathode and the at least one anode in combination are positioned to electrolyze the solvent and thereby generate the first gas and the second gas, wherein a plurality of cathode perforations of the cathode are sized to both permit the first gas to enter the cathode volume and obstruct the second gas from passing into the cathode volume, and the first gas becomes entrained in the solution and the second gas escape upwards and away from the cathode, and the solution with first gas entrained in the solution are both permitted to enter the cathode volume; (c.) an output channel coupled with the cathodes and through which the solution and the first gas entrained in the solution passes through each individual cathode volume and exits the tank via the output channel; and (d.) a pump coupled with the output channel and configured to generate a pulling force within the output channel, whereby the solution and the first gas entrained in the solution are pulled out of the tank.

Even additional alternate preferred embodiments of the present inventions comprise one or more of the following aspects: (a.) a tank forming an inner volume, the inner volume containing an electrolytic solution (“the solution”) and the tank configured to enable gaseous emissions to escape upwards from the solution, wherein the solution comprises water as a solvent; (b.) an input feature extending wholly into the tank from a tank exterior, and through which the solution flows into the inner volume; (d.) an output channel coupled with the cathode and through which, in combination with the cathode volume, the entrained in the solution and the first gas entrained in the solution exit the tank; (d.) a pump coupled with the output channel and configured to generate a pulling force within the output channel, whereby the solution and the first gas entrained in the solution are pulled out of the tank; (e.) a plurality of anodes positioned within the inner volume; and (f.) a plurality of perforated cathodes (“the cathodes”), each cathode of the plurality of cathodes forming an individual cathode volume, whereby each cathode and the each anode are paired and positioned to electrolyze the solvent and thereby generate the first gas and the second gas, and the solution with first gas entrained in the solution are permitted to enter the individual cathode volumes and the second gas is free to proceed upward and away from the perforated cathode; and (g.) the output channel coupled with the cathodes and through which, in combination with the individual cathode volumes, the entrained in the solution and the first gas entrained in the solution exit the tank.

We employ two factors in the process of separation of the H2 gas from the O2 gas: screening based on bubble size and separation via buoyancy. When the first gas is O2 gas bubbles and the second gas is H2 gas bubbles, the relative bubble sizes produced by the method of the present invention are larger for the O2 bubbles than for the H2 bubbes, and the large bubble size of O2 means that its buoyance is much larger than that of the H2 and therefore the O2 gas rises much faster.

Other additional preferred embodiments of the present invention include one or more of the following aspects: (a.) at least two anode plates; (b) at two perforated cathode positioned between the two anode plates, the cathode forming an internal cathode volume, wherein a plurality of cathode perforations permit gaseous hydrogen to enter the cathode volume, whereby the cathode and the at least two anodes in combination are configured to electrolyze the solvent and thereby generate (1.) gaseous hydrogen entrained in the solution and (2.) gaseous oxygen, whereby the gaseous oxygen is enabled to escape upwards from the solution to exit the tank; (c.) an output channel coupled with the perforated cathode and positioned to accept the solution and the gaseous hydrogen entrained in the solution, and through which the solution and gaseous hydrogen exits the tank; and (d.) a pump coupled with the output channel and configured to generate a pulling force within the output channel, whereby the solution and the gaseous hydrogen entrained in the solution are pulled out of the tank; (e.) a plurality of anode plates; (f.) a plurality of perforated cathodes, each perforated cathode forming an individual cathode volume, wherein each perforated cathode forms a plurality of cathode perforations that are sized to permit the solution and entrained gaseous hydrogen to enter each individual cathode volume, and further to obstruct gaseous oxygen from passing into any individual cathode volume; (g.) each of the plurality of anode plates positioned on either side of a pair of perforated cathode plates, whereby each perforated cathode plate pair is subjected to electromagnetic force from an anode plate on either outside face of either of the cathode plates; (h.) the output channel is further configured to couple with, and is coupled with, each individual cathode volume formed by each cathode pair, whereby the output channel accepts the solution and the gaseous hydrogen entrained in the solution, and the solution and gaseous hydrogen is pulled out of the tank via the output channel by the pulling force generated by the pump; (i.) at least one non-planar anode plate; (j.) at least one non-planar the cathode plate;

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE SEVERAL VIEWS OF THE DRAWINGS

FIG. 1A is a side view of a cylindrical embodiment of the present invention, and disclosing Hydrogen gas bubbles and Oxygen gas bubbles in an electrolytic solution;

FIG. 1B is a detailed cutaway top view of a cylindrical embodiment of FIG. 1A;

FIG. 2A is a side view of a three cylindrical series embodiment of the present invention;

FIG. 2B is a detailed cutaway side view of a cylindrical embodiment of FIG. 2A;

FIG. 3 is a cutaway side view of a third preferred embodiment of the present invention having a tank housing the electrolytic solution of FIG. 1A, a plurality of elongated perforated tubular cathodes, and a plurality of tubular anodes plates, wherein each elongated perforated cathode is at least partially contained within the surrounding anode;

FIG. 4 is a partial detailed representation of the first cylindrical device of FIG. 1A and showing the behavior of the Hydrogen gas bubbles and the behavior of the Oxygen gas bubbles in the electrolytic solution;

FIG. 5 is a cutaway side view of a fourth system configuration that comprises one elongated cathode of FIG. 3 and shows the movement of liquid and gases with the surrounding tank;

FIG. 6 is an optional skimmer structure of the fourth system of FIG. 5;

FIG. 7 is an illustration of the electrical connections according to the invented method applied to a flat plate system;

FIG. 8 illustrates additional details of the flat plate preferred embodiment of FIG. 8;

FIG. 9 is a top view of an alternate plenum of the fifth flat plate embodiment of FIG. 8;

FIG. 10A is a cutaway sideview of a spherical embodiment of the present invention having a spherical perforated cathode positioned within a spherical anode; and

FIG. 10B is a notional sideview spherical embodiment of the present invention of FIG. 10A that indicates the separate directionality of the Hydrogen gas bubbles and the Oxygen gas bubbles in moving from the spherical perforated cathode and the spherical anode respectively

### DETAILED DESCRIPTION OF THE INVENTION

In the following detailed description of the invention, numerous details, examples, and embodiments of the invention are described. However, it will be clear and apparent to one skilled in the art that the invention is not limited to the embodiments set forth and that the invention can be adapted for any of several applications.

Throughout this specification, like reference numbers signify the same elements throughout the description of the Figures. The detailed description of some embodiments of the invention is made below with reference to the accompanying figures, wherein like numerals represent corresponding parts of the figures.

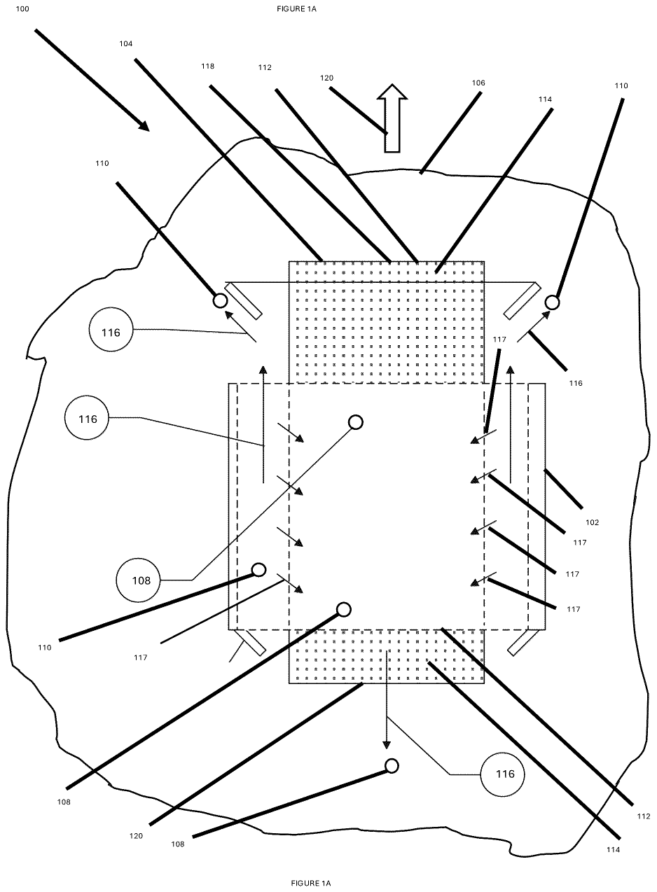

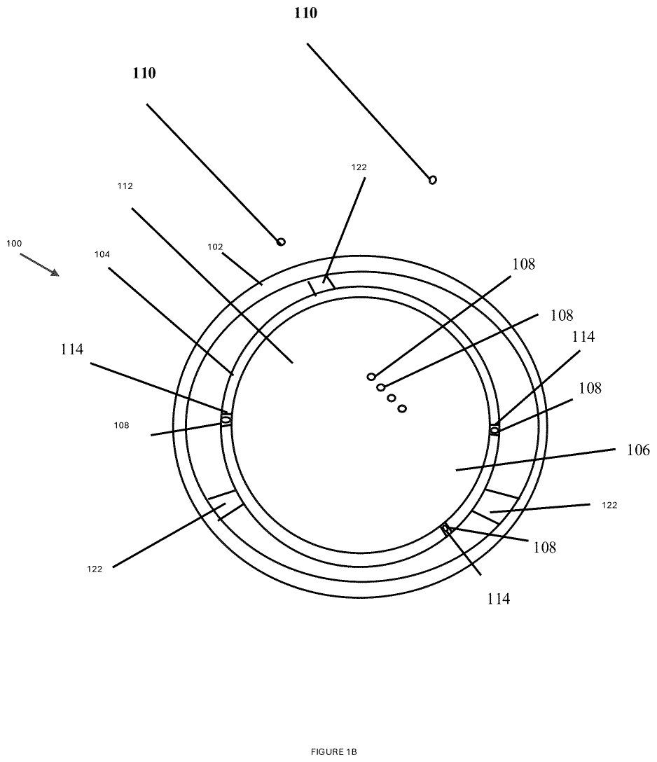

Referring now generally to the Figures and particularly to FIGS. 1A and 1B, FIG. 1A is a side view of a cylindrical embodiment of the present invention 100 (hereinafter, “the cylindrical device 100”), wherein an annular anode 102 encompasses a perforated cathode 104. The cylindrical device 100 is bathed in an electrolytic solution 106 having water as a solution in which both the annular anode 102 and the perforated cathode 104 act by electrolysis to separate water molecules into Hydrogen gas bubbles 108 and Oxygen gas bubbles 110, i.e., the water molecules pick up electrons at the negatively charged perforated cathode 104 partially segment into released Hydrogen gas bubbles 108, whereas water molecules lose electrons at the anode 102, or positive electrode, and partially segment into Oxygen gas bubbles 110.

The electrolytic solution 106, the oxygen gas bubbles 110, and the Hydrogen gas bubbles 108 are all placed under a pressure that pulls the Hydrogen gas bubbles 108 into an internal volume 112, as shown in FIG. 1B, of the perforated cathode 104 through a plurality of cathode perforations 114 (hereinafter “the perforations 114”) of the perforated cathode 104, as indicated by hydrogen travel arrows 117.

The anode 102 preferably comprises or is (a.) a suitable Dimensionally Stable Anode known in the art; (b.) Carbon/Graphite; (c.) Platinum; (d.) titanium coated with one or more mixed metal oxides such as, ruthenium oxide or iridium oxide; (e.) Lead dioxide; (f.) and/or other suitable materials known in the art.

It is understood that the perforated cathode 104 may be or comprise of a mesh fabric, a screen, or a multiply apertured sheet, wherein the scope of meaning of the terms “perforations” as applied within the present disclosure include through holes, piercings and the like that extend fully through the perforated cathode 104. In another aspect, the anode 114 may be or comprise a conductive material including, but not limited to, an alloy of nickel and copper, such as a monel, or other suitable conductive material known in the art that has sufficient, electrical conductivity, electrochemical stability in the electrolyte, and an application-appropriate electrochemical potential for the intended environment of the cylindrical device 100. It is understood that the perforated cathode 104 could alternatively and/or partially comprise or be composed of a frame (not shown) supporting a mesh material. The perforations 114 of the cathode 104 preferably number between 25 per linear inch and 200 per linear inch.

The perforations 114 are preferably sized to form a diameter within the range of less than 74 microns to more than 700 microns. Accordingly, the perforations 114 are each large enough to accept a passage of the Hydrogen gas bubbles 108 into the internal volume 112 of the perforated cathode 104 as indicated by the hydrogen gas travel of arrows 117, while being small enough to obstruct a passage of the Oxygen gas bubbles 110 into the internal volume 112 of the perforated cathode 104. A cathode endcap 118 seals off the internal volume 112 and may comprise additional perforations 114. An outlet 120 of the perforated cathode 104 enables hydrogen gas 108 to travel freely, and under pressure, from the internal volume 112 of the perforated cathode 104 as shown in the Figures.

The Oxygen gas bubbles 110 are less dense than the surrounding electrolytic solution 106 and typically float in an upwards direction through the electrolytic solution 106, as indicated by the vector arrows 116 and 120.

Referring now generally to the Figures and particularly to FIG. 1B, FIG. 1B is a detailed cut-away top view of the perforated cathode 104 and showing the hydrogen gas bubbles 106 having successfully passed through the perforations 114 and into the internal volume 112 of the perforated cathode 104. One or more insulating stand-offs 124 maintain a displacement between the anode 102 and the perforated cathode 104. The insulating stand-offs 122 may be or comprise natural rubber, non-conductive plastic, or other suitable material known in the art. It is understood that the insulating stand-off 122 may be comprised within one or more rings of perforated material that maintain a displacement between the anode 102 and the perforated cathode 104 while allowing oxygen gas bubbles 110 to proceed upwards.

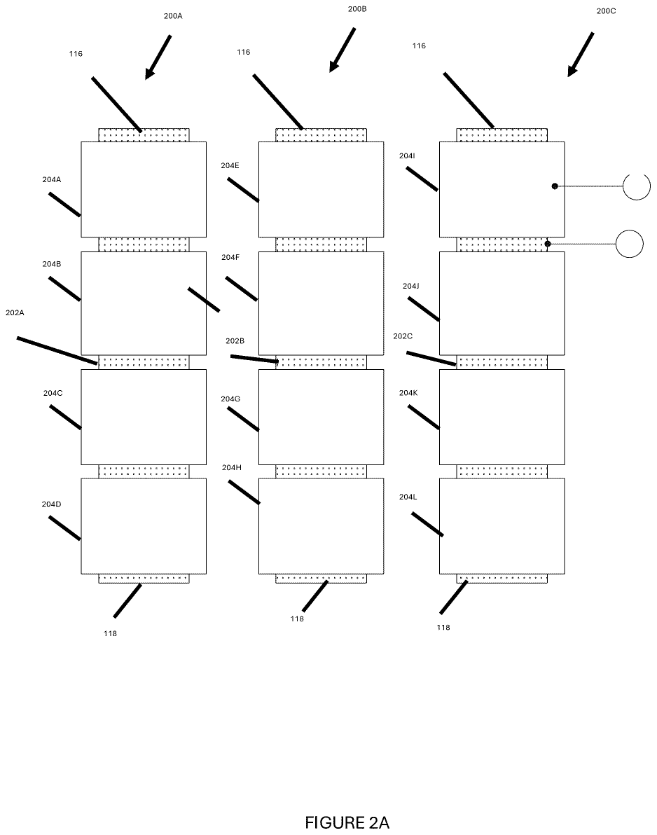

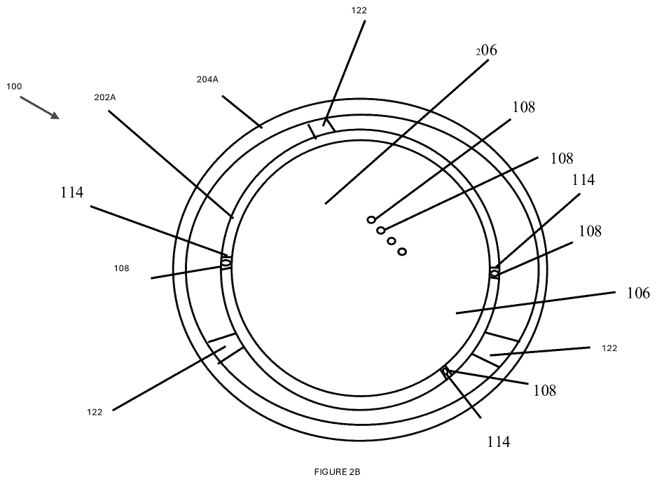

Referring now generally to the Figures and particularly to FIG. 2A, FIG. 2A is a side view of three cylindrical series embodiment of the present invention 200A-200C (hereinafter, “the cylindrical series 200A-200C”). Each of the cylindrical series 200A-200C comprises one elongated cylindrical perforated cathode 202A-202C (hereinafter, the “elongated cathode 202A-202C”) having a multiplicity of the perforations 114, and a plurality of alternate annular anodes 204A-204I. The alternate annular anodes 204A-204I are placed in individual series to separately encompass each of the elongated cathodes 202A-202C. The elongated cathodes 202A-202C also each comprise one endcap 116 and one outlet 118.

It is understood that the elongate cathodes 202A-202C may be or comprise a mesh fabric, a screen, or a multiply apertured sheet, wherein the scope of meaning of the terms “perforations” as applied within the present disclosure include through holes, piercings and the like that extend fully through elongate cathodes 202A-202C. In another aspect, the elongate cathodes 202A-202C may be or comprise a conductive material including, but not limited to, an alloy of nickel and copper, such as a monel, or other suitable conductive material known in the art that has sufficient, electrical conductivity, electrochemical stability in the electrolyte, and an application-appropriate electrochemical potential for the intended environment of the elongated cathodes 202A-202C. It is understood that the elongated cathodes 202A-202C could alternatively and/or partially comprise or be composed of a frame (not shown) supporting a mesh material. The perforations 114 of the elongate cathodes 202A-202C preferably number between 25 per linear inch and 200 per linear inch in two dimensions.

Referring now generally to the Figures and particularly to FIG. 2B, FIG. 2B is a cut-away top view of the first cylindrical series 200A and showing the hydrogen gas bubble 106 having successfully passed through the perforations 114 and into an elongated internal volume 206, as formed by the first elongated cathode 202A. A first alternate annular anode 204A is shown encompassing the first elongated cathode 202A.

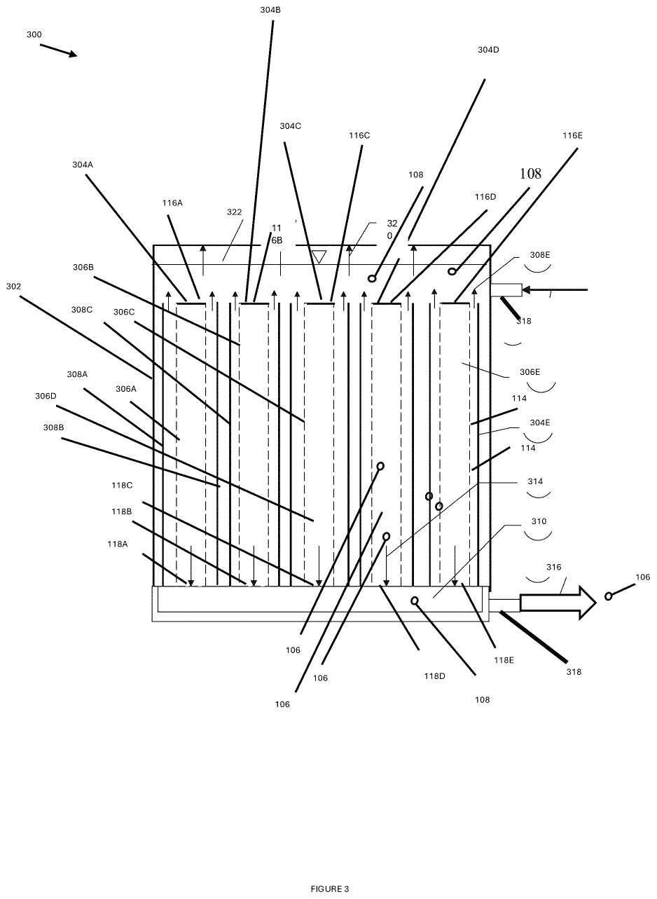

Referring now generally to the Figures and particularly to FIG. 3, FIG. 3 is a cutaway side view of a third preferred embodiment of the present invention (hereinafter, “the third configuration 300”) having a tank 302 housing a plurality of cylindrical elongated perforated cathodes 304A-304E (hereinafter, “third cathodes 304A-304E”). Each third cathode 304A-304E forms a third internal volume 306A-306E. Each third cathode 304A-304E is positioned between two cylindrical anode plates 308A-308F that are also housed within the tank 302. Each third cathode 304A-304E comprises one endcap 116A-116E and one outlet 118A-118E. The third cathodes 304 and their outlets 118A-181E are each coupled with a same plenum 310. The plurality of anode plates 308A-308F are also anchored in the plenum 310. The Hydrogen gas bubbles 108 and the electrolytic solution 106 pass through the perforations 114 and into the third internal volumes 306. The Hydrogen gas bubbles 108 and electrolytic solution 106 travel downwards 314 and towards and then through the plenum 310 to exit the tank 302 via an outlet channel 318 along an output vector 316.

The electrolytic solution 106 flows under pressure into the tank 302 through an input channel 318. The Oxygen gas bubbles 110 being less dense then the electrolytic solution 106 float in an upward direction 320 and toward a top surface 322 of the electrolytic solution 106 and thereby exits the tank 302.

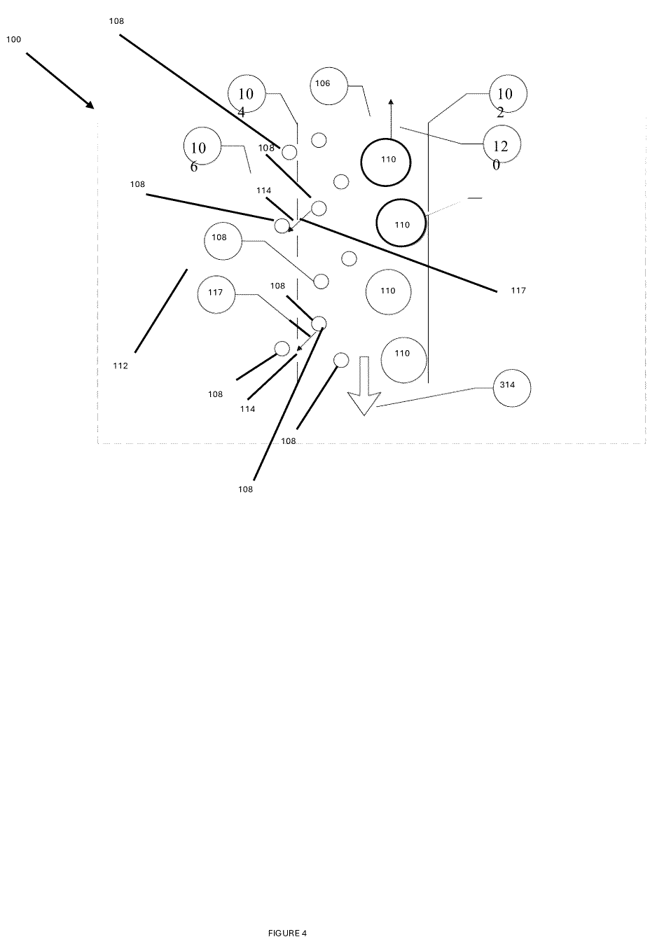

Referring now generally to the Figures and particularly to FIG. 1 though FIG. 4, FIG. 4 is a partial detailed representation of the first cylindrical device 100 and showing the behavior of the Hydrogen gas bubbles 108 and the behavior of the Oxygen gas bubbles 110 in the electrolytic solution 106. The electrolytic solution 106 passes through the perforations 114 and into the internal volume 112 of the perforated cathode 104. The Hydrogen gas bubbles 108 are produced at the cathode 104 and follow along hydrogen travel arrows 117 to pass through the perforations 114, and then downwards 314.

The Oxygen gas bubbles 110 are too large to pass through the perforations 114 and remain outside all of the first cathode volume and rise upwards on the basis of being less dense than the surrounding electrolyte solution 106. The Oxygen gas bubbles 110 are produced at the surface of the annular anode 102.

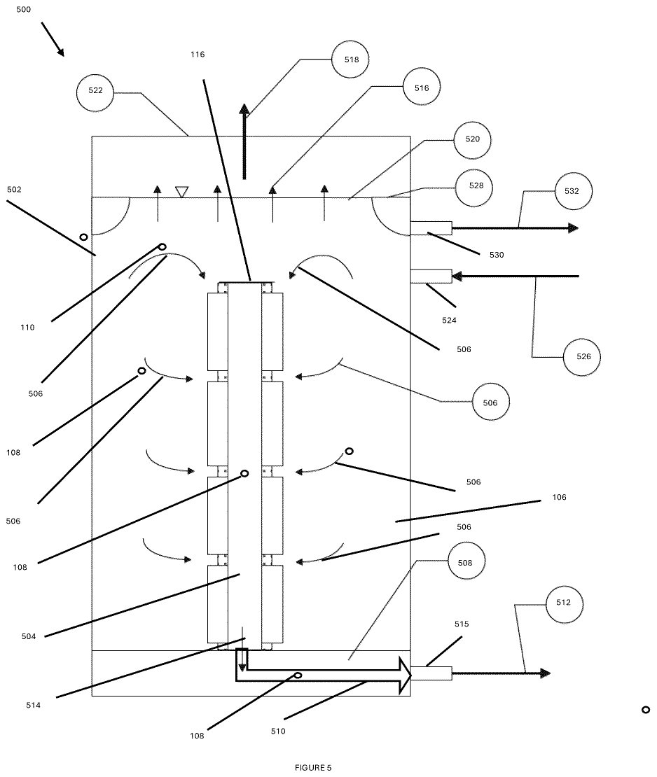

Referring now generally to the Figures and particularly to FIG. 5, FIG. 5 is a cutaway side view of a fourth system configuration 500 that comprises one elongated, cylindrical perforated cathode 202A placed within the electrolytic solution 106 contained by an alternative tank 502 and having four annular cathode segments 204A-204D positioned around the cylindrical perforated cathode 202A. The cylindrical perforated cathode 202A forms a plurality of perforations 114 through which Hydrogen gas bubbles 108 enter into an alternative cathode volume 504. The endcap 116 is preferably either a solid sheet or forms alternative perforations 114 so that no Oxygen gas bubbles 110 may enter into the alternative cathode volume 504. A plurality of electrolyte pathway arrows 506 indicate various directions from which the liquid electrolyte passed into the annular space between the anode segments and the cathode. The cylindrical perforated cathode 202A is coupled at outlet 118 to an alternative plenum 508 that provides a plenum channel 510 through which the Hydrogen gas molecules 108 and some electrolytic solution 106 the plenum 514 has received exit the tank 502 via the plenum channel 510 and in an outflow direction 512 through an output channel 515. An exit pathway arrow 514 indicates how Hydrogen gas bubbles 108 flow into the alternative plenum 508. A plurality of topside arrows 516 exiting the alternative tank 502 as indicated the exit direction 518 of Oxygen gas bubbles 110 through an alternative top surface 520 of the electrolytic solution 106 and beyond a top 522 of the alternative tank 502.

The electrolytic solution 106 contained within the alternative tank 502 is delivered into the tank 502 via an input channel 524 and as indicated by an input directional arrow 526. An optional structure 528 alternatively captures Hydrogen gas bubbles 108 from the liquid surface 520 of the electrolytic solution 106 and passes these hydrogen gas bubbles 108 with some electrolytic solution 106 out of the tank 502 via a topside output channel 530 and as indicated by an input directional arrow 532.

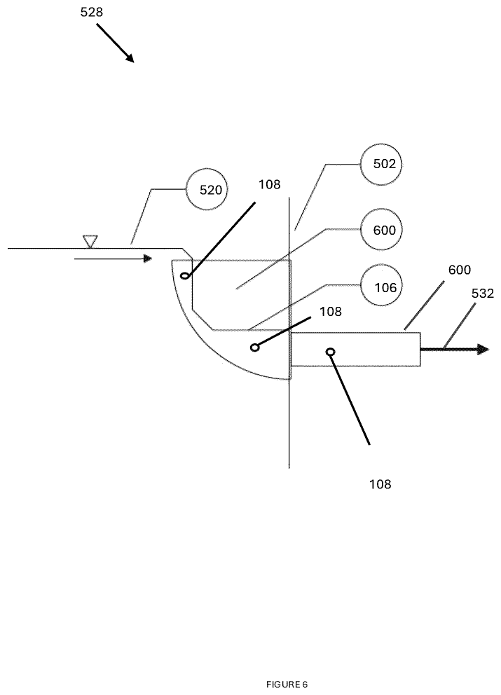

Referring now generally to the Figures and particularly to FIG. 6, FIG. 6 is a detailed optional skimmer structure 528 that additionally captures Hydrogen gas bubbles 108 from the alternative top surface 520 of the electrolytic solution 106 and into a trough 600. While possibly most Hydrogen bubbles produced by electrolysis are pulled toward the plenum channel 510, a minority of the Hydrogen bubbles rise to the top surface 520. The trough 600 is coupled with the topside output channel 530, wherein the trough 600 preferably encircles the tank 502 and is shaped to pass, under the influence of gravity, these captured hydrogen gas bubbles 108 with some also captured electrolytic solution 106 out of the tank 502 via the topside output channel 532.

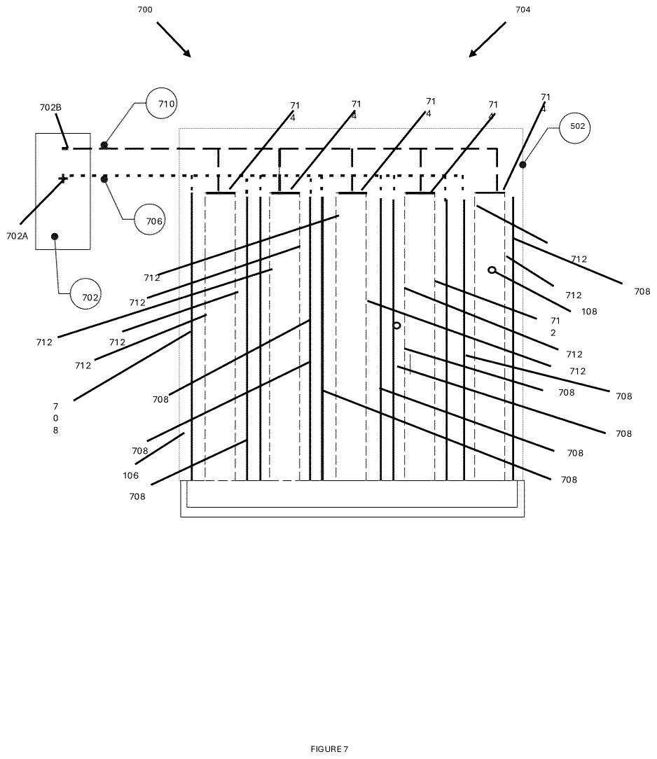

Referring now generally to the Figures and particularly to FIG. 7, FIG. 7 is an illustration of the electrical connection network 700 that electrically connects a voltage source 702 to a plate embodiment of the present invention 704 (hereinafter, “the plate system” 704”) that is positioned within the alternative tank 502. A positive lead 706 electrically connects a positive pole 702A of the voltage source 702 to each of a plurality of electrically conductive plurality of plate anodes 708. In addition, a negative lead 710 electrically connects a negative pole 702B of the voltage source 702 through a plurality of electrically conductive plate cathodes 712. The plate cathodes 712 are separated into pairs by one endplate 714 of a plurality of endplates. Each endplate 714 of a plurality of endplates electrically and structurally couple one pair of plate cathodes 712.

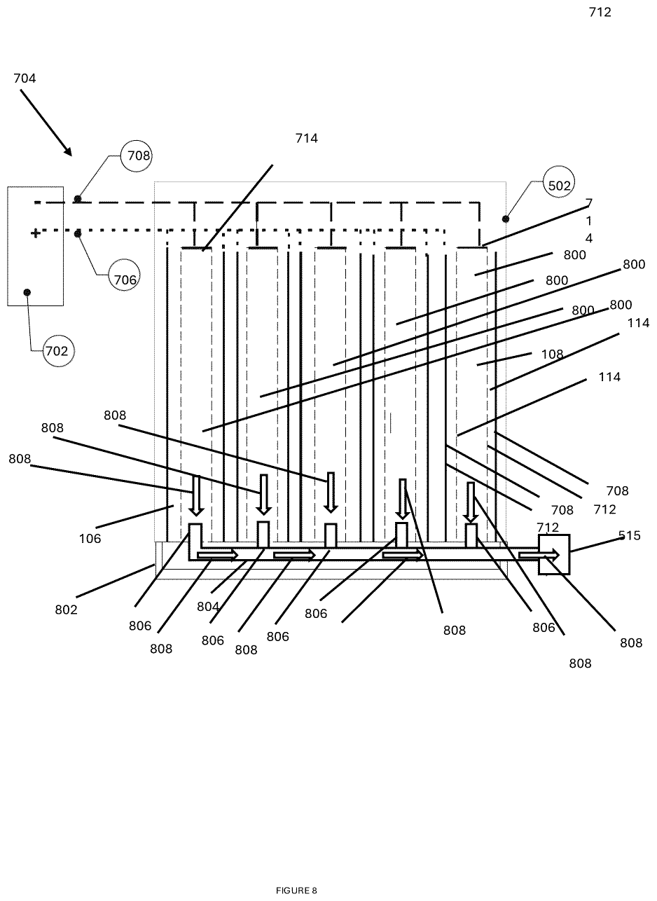

Referring now generally to the Figures and particularly to FIG. 8, FIG. 8 is an illustration of more details of the plate system 704. Each of the plurality of plate cathodes 712 are paired off, electrically and structurally coupled by a single end plate 714, and positioned between two plate anodes 708. Each pair of plate cathodes 712 in combination with one dedicated end plate 714 form a separate plate cathode inner volume 800 into which Hydrogen gas bubbles 108 pass via pluralities of perforations 114 formed by the paired plate cathodes 712. Each end plate 714 may be a solid sheet or form perforations 114 as well.

Each plate anode 706 and each pair of plate cathodes 710 are removably affixed and coupled to an alternate plenum 802. The alternate plenum 802 provides an alternate plenum channel 804 that is coupled with the plate cathode inner volumes 800 into which the Hydrogen gas molecules 106 and some electrolytic solution 106 enter. The alternate plenum channel 804 receives the Hydrogen gas molecules 108 and some electrolytic solution 106 preferably from each plate cathode inner volume 800. The Hydrogen gas molecules 106 and some electrolytic solution 106 received by the alternate plenum channel 804 exit the alternative tank 502 via the output channel 515. A plurality of alternate exit pathway arrows 808 indicate the directions by which Hydrogen gas bubbles 108 pass from each plate cathode inner volume 800 and into the alternate plenum channel 804 via plenum ports 806.

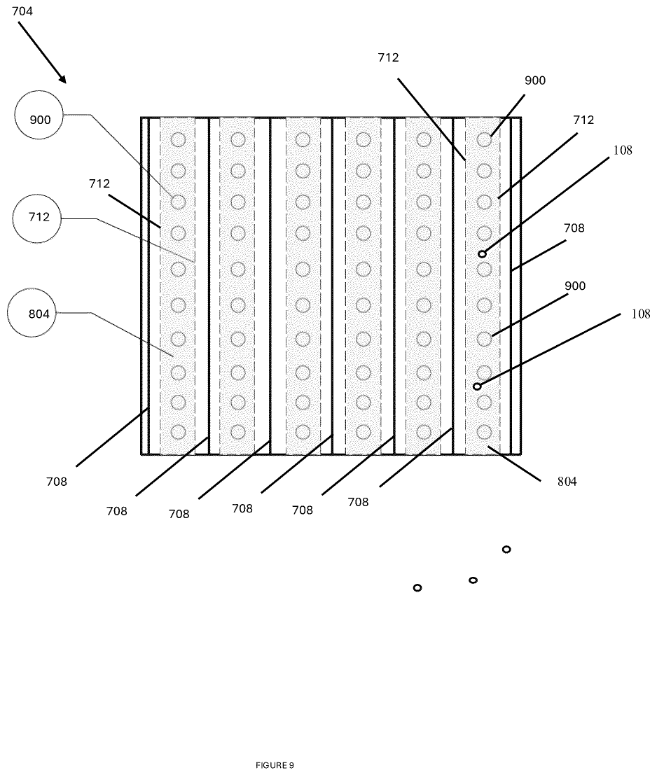

Referring now generally to the Figures and particularly to FIG. 9, FIG. 9 is an isolated top view of the alternate plenum 802 of the plate system 104. The plurality of plenum ports 900 are positioned between one pair of plate cathodes 712 and accept the Hydrogen gas bubbles 108 that are heading downwards and into the alternate plenum channel 804.

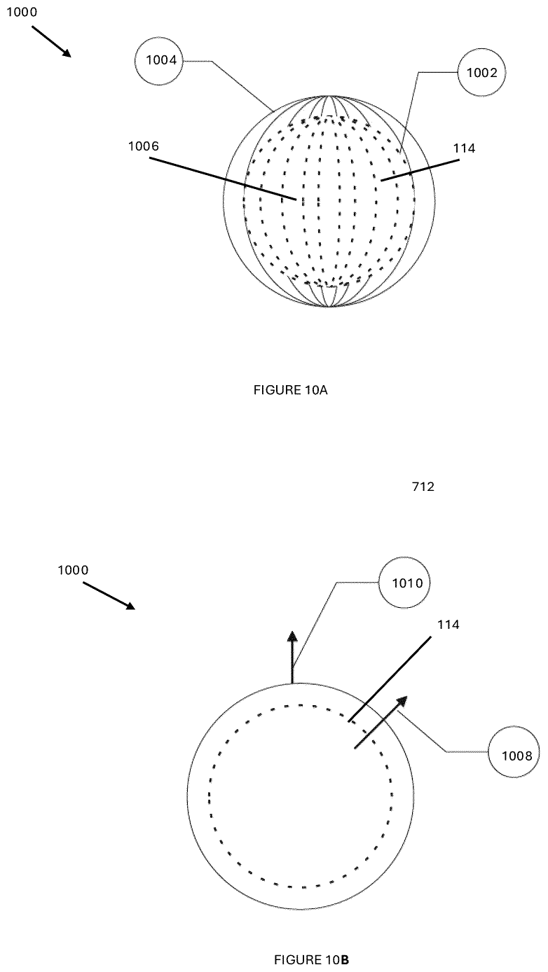

Referring now generally to the Figures and particularly to FIGS. 10A and 10B, FIG. 10A is a side cutaway view of a spherical embodiment of the present invention (hereinafter, “the sphere 1000”) having a spherical perforated cathode 1002 positioned within a spherical anode 1004. The perforations 114 of the spherical perforated cathode 1002 allow Hydrogen gas bubbles 108 to pass into an inner sphere volume 1006 and prohibit the Oxygen gas bubbles 110 from entering the inner sphere volume 1006.

FIG. 10B is a notional side view of the sphere 1000 and presents a first directional arrow 1008 indicating a first direction that the Hydrogen gas bubbles 108 follow as the Hydrogen gas bubbles 108 exit the inner sphere volume 1006. A second directional arrow 1010 indicates a second direction that the Oxygen gas bubbles 110 follow when floating upwards from and away from the sphere 1000. It is understood the sphere 1000 is immersed in the electrolytic solution 106 (not shown).

It is to be understood that this invention is not limited to particular aspects of the present invention described, as such may, of course, vary. It is also to be understood that the terminology used herein is for the purpose of describing particular aspects only, and is not intended to be limiting, since the scope of the present invention will be limited only by the appended claims. Methods recited herein may be carried out in any order of the recited events which is logically possible, as well as the recited order of events. The present invention and/or the invented method may be embodied as devices, systems, and/or methods

Where a range of values is provided herein, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the range's limits, an excluding of either or both of those included limits is also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the methods and materials are now described.

It must be noted that as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

While selected embodiments have been chosen to illustrate the invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment, it is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A device comprising:
a tank forming an inner volume, the inner volume containing an electrolytic solution (“the solution”) and the tank configured to enable gaseous emissions to escape upwards from the solution, wherein the solution comprises unpurified water as a solvent;
an input feature coupled with the tank, and through which the solution flows into the inner volume;
at least one tubular anode;
at least one perforated tubular cathode (“the cathode”) positioned at least partially within the tubular anode, the cathode forming a cylindrical cathode volume, wherein a plurality of cathode perforations of the cathode are sized to both permit gaseous hydrogen to enter the cylindrical cathode volume and obstruct gaseous oxygen from passing into the cylindrical cathode volume, whereby the cathode and the at least one tubular anode in combination are configured to electrolyze the solvent and thereby generate gaseous hydrogen and gaseous oxygen, and wherein the gaseous hydrogen is free to become entrained in the solution, and the gaseous oxygen is free to escape upwards and away from the tubular cathode, and the solution entraining gaseous hydrogen is permitted to enter the cylindrical cathode volume;
an output channel through which the solution with entrained hydrogen gas exits the tank; and
an output pump coupled with the output channel and configured to generate a pulling force within the output channel, whereby the solution and the gaseous hydrogen entrained in the solution are pulled out of the tank, whereby the device is turned on and off without damage.

2. The device of claim 1, the device further comprising:
a skimmer basin positioned at a top of the tank and above the input feature, and the skimmer basin shaped and positioned to accept an overflow of solution from the top of the tank;
a skimmer channel coupled with the skimmer basin, the skimmer channel shaped and configured to enable the solution with entrained hydrogen to exit the skimmer basin;
a perforated skimmer screen forming a plurality of skimmer perforations, the perforated screen positioned between the top of the tank and the skimmer channel, wherein the skimmer perforations are each sized to both permit the solution with entrained gaseous hydrogen to flow out of the tank and to obstruct gaseous oxygen from entering the skimmer channel.

3. The device of claim 2, wherein the perforated skimmer screen is placed between the top of the tank and the skimmer basin.

4. The device of claim 2, wherein the perforated skimmer screen is placed between the skimmer basin and the skimmer channel.

5. The device of claim 2, further comprising a skimmer pump coupled with the skimmer channel and configured to generate a pulling force within the skimmer channel, whereby the solution and the gaseous hydrogen entrained in the solution are pulled out of the tank via the skimmer.

6. The device of claim 1, wherein the anode is cylindrically shaped and at least partially encloses the cathode.

7. The device of claim 6, wherein the anode forms an anode inner volume, wherein the cathode at least partially extends into the anode inner volume.

8. The device of claim 1, the cathode comprises a cathode material selected from the group of cathode materials consisting of Carbon, Graphite, Platinum, Titanium coated with a metal oxide, Titanium coated with Ruthenium Oxide, Titanium coated with Iridium Oxide, Lead dioxide, and stainless steel.

9. The device of claim 1, wherein the anode comprises an anode material selected from the group of anode materials consisting of Carbon, Graphite, Platinum, Titanium coated with a metal oxide, Titanium coated with Ruthenium Oxide, Titanium coated with Iridium Oxide, Lead dioxide, and stainless steel.

10. The device of claim 1, wherein each cathode perforation of the plurality of cathode perforations are sized to fit within a diameter sized within the range of from 74 microns to 700 microns.

11. A device comprising:
a tank forming an inner volume, the inner volume containing an electrolytic solution (“the solution”) and the tank configured to enable gaseous emissions to escape upwards from the solution, wherein the solution comprises water as a solvent;
an input feature extending wholly into the tank from a tank exterior, and through which the solution flows into the inner volume;
at least one anode;
at least one perforated cathode (“the cathode”), the cathode forming a cathode volume, whereby the cathode and the at least one anode in combination are positioned to electrolyze the solvent and thereby generate a first gas and a second gas, wherein a plurality of cathode perforations of the cathode are sized to both permit the first gas to enter the cathode volume and obstruct the second gas from passing into the cathode volume, and the first gas becomes entrained in the solution and the second gas escapes upwards and away from the cathode, and the first gas entrained in the solution is permitted to enter the cathode volume;
an output channel coupled with the cathode and through which the solution and the first gas entrained in the solution passes through the cathode volume and exits the tank via the output channel; and
a pump coupled with the output channel and configured to generate a pulling force applied to the output channel, whereby the solution and the first gas entrained in the solution are pulled out of the tank.

12. The device of claim 11, wherein the anode forms an anode inner volume, wherein the cathode at least partially extends into the anode inner.

13. The device of claim 11, wherein the cathode is cylindrically shaped.

14. The device of claim 11, wherein the anode is cylindrically shaped and at least partially encloses the cathode.

15. The device of claim 11, further comprising:
a plurality of anodes;
a plurality of perforated cathodes (“the cathodes”), each cathode forming an individual cathode volume, whereby the cathode and the at least one anode in combination are positioned to electrolyze the solvent and thereby generate the first gas and the second gas, wherein a plurality of cathode perforations of the cathode are sized to both permit the first gas to enter the cathode volume and obstruct the second gas from passing into the cathode volume, and the first gas becomes entrained in the solution and the second gas escape upwards and away from the cathode, and the solution with first gas entrained in the solution are both permitted to enter the cathode volume;
an output channel coupled with the cathodes and through which the solution and the first gas entrained in the solution passes through at least one cathode volume and exits the tank via the output channel; and
a pump coupled with the output channel and configured to generate a pulling force within the output channel, whereby the solution and the first gas entrained in the solution are pulled out of the tank.

16. A device comprising:
a tank forming an inner volume, the inner volume containing an electrolytic solution (“the solution”) and the tank configured to enable gaseous emissions to escape upwards from the solution, wherein the solution comprises water as a solvent;
an input feature extending wholly into the tank from a tank exterior, and through which the solution flows into the inner volume;
at least one anode;
at least one perforated cathode (“the cathode”) positioned below the anode, the cathode forming a cathode volume, the cathode having a plurality of perforations through which each first gas bubble of a plurality first gas bubbles are sufficiently small to pass through the plurality of perforations and enter the cathode volume, and wherein each second gas bubble of a plurality of second gas bubbles are too large to pass through the perforations and enter the cathode volume, whereby the at least one cathode and the at least one anode in combination are positioned to electrolyze the solvent and thereby generate the plurality of first gas bubbles and the plurality of second gas bubbles, and thereby the solution with the plurality of first gas bubbles entrained therein is permitted to enter the cathode volume, and the plurality of second gas bubbles is free to proceed upward and away from the cathode;
an output channel coupled with the cathode volume and through which the plurality of first gas bubbles entrained in the solution exit the tank; and
a pump coupled with the output channel and configured to generate a pulling force applied to and within the cathode volume and the output channel, whereby the solution with the plurality of first gas bubbles entrained are pulled out of the tank.

17. The device of claim 16, wherein each perforation of the plurality of perforations are sized to fit within a diameter sized within the range of from 74 microns to 700 microns.

18. A device comprising:
a tank forming an inner volume, the inner volume containing an electrolytic solution (“the solution”) comprising water as a solvent, and the tank configured to enable gaseous emissions to escape upwards from the solution;
an input feature extending coupled with the tank from a tank exterior, and through which the solution flows into the inner volume;
at least two anode plates (“the anode plates”);
at least one two perforated cathodes (“the two cathodes”) positioned between the two anode plates, the two cathodes forming a cathode volume, wherein a plurality of cathode perforations permit gaseous hydrogen bubbles to enter the cathode volume and obstruct gaseous oxygen bubbles, whereby the cathodes and the anode plates in combination are configured to electrolyze the solvent and thereby generate (1.) gaseous hydrogen bubbles entrained in the solution and (2.) gaseous oxygen bubbles, whereby the gaseous oxygen bubbles are enabled to escape upwards from the solution to exit the tank;
an output channel coupled with the perforated cathode and positioned to accept the solution and the gaseous hydrogen bubbles entrained in the solution, and through which the solution and gaseous hydrogen exits the tank; and
a pump coupled with the output channel and configured to generate a pulling force applied to the cathode volume and the output channel, whereby the solution with gaseous hydrogen bubbles entrained therein are pulled out of the tank.

19. The device of claim 18, further comprising:
a plurality of anode plates;
a plurality of perforated cathodes, each perforated cathode forming an individual cathode volume, wherein each perforated cathode forms a plurality of cathode perforations that are sized to (a.) permit the solution and entrained with gaseous hydrogen bubbles to enter at least one individual cathode volume, and (b.) further to obstruct gaseous oxygen bubbles from passing into any individual cathode volume;
each of the plurality of anode plates positioned on either side of one pair of the plurality of perforated cathodes, whereby each pair of perforated cathode plates are subjected to electromagnetic force sourced from at least two anode plates; and
the output channel is further configured to couple with, and is coupled with, each individual cathode volume of the plurality of cathodes, whereby the output channel accepts the solution and the gaseous hydrogen bubbles entrained therein, and the gaseous hydrogen bubbles are thereby pulled out of the tank via the output channel by the pulling force generated by the pump.

20. The device of claim 19, wherein at least the anode plate is non-planar.

21. The device of claim 19, wherein at least the perforated cathode is non-planar.

22. The device of claim 19, wherein each cathode perforation of the plurality of cathode perforations are sized to fit within a diameter sized within the range of from 74 microns to 700 microns.

23. A device comprising:
means to electrolyze a solution that generates a first gas and a second gas;
means to separate the first gas from the second gas, whereby the first gas is entrained within the solution;
means to extract the separated and entrained first gas while inhibiting the second gas from being extract with the entrained first gas.
